(19) United States
(12) Patent Application Publication
(10) Pub. No.: US 2013/0337134 A1
(43) Pub. Date: Dec. 19, 2013

(54) METHOD AND APPARATUS FOR THAWING A FROZEN ITEM

(71) Applicant: Thawctopus LLC, Dallas, TX (US)

(72) Inventors: Jeremy R. Frazer, Dallas, TX (US); Joseph P. Edsell, Dallas, TX (US)

(21) Appl. No.: 13/921,669

(22) Filed: Jun. 19, 2013

Related U.S. Application Data
(60) Provisional application No. 61/661,678, filed on Jun. 19, 2012.

(51) Int. Cl. A23L 3/365

(52) U.S. Cl. CPC A23L 3/365
USPC 426/506; 99/483

(57) ABSTRACT

The present disclosure provides a method and apparatus for thawing a frozen item. The apparatus is capable of suspending or retaining a frozen item (typically a frozen food) in a liquid such that the frozen item remains submerged, thus allowing for the transfer of heat from the liquid to substantially the entire surface area of the frozen item, thereby accelerating the thawing process and ensuring an even thaw. This allows the user to monitor and/or conserve use of the liquid by using a desired amount (typically just enough to fully submerge the frozen item so that the liquid surrounds substantially the entire surface area of the frozen item and/or so that the liquid can circulate above and below the submerged frozen item). Moreover, because the frozen item remains submerged, the user does not have to rotate, flip or otherwise tend to the frozen item to ensure an even thaw.

### CROSS-REFERENCE TO RELATED APPLICATIONS

Pursuant to 35 U.S.C. §119(e), this application claims priority from, and hereby incorporates by reference for all purposes, United States Provisional Patent Application Serial No. 61/661,678, entitled “Device that Speeds up Thawing Process by Keeping Frozen Item Submerged in a Liquid,” filed Jun. 19, 2012, and naming Jeremy Frazer as inventor.

### BACKGROUND

Conventional techniques for preparing frozen food include placing a frozen item in a microwave or sink to allow the frozen item to thaw. Unfortunately, when placed in a microwave, food can be thawed unevenly and often has an unpleasant texture or consistency. Food placed in a sink to thaw generally maintains a more pleasant texture, yet this process can be inefficient or time-consuming. For example, one inefficient technique involves placing the frozen item in the sink and running water over the frozen item until it is thawed. This results in a significant waste of water and is difficult to achieve an even thaw. Another technique involves filling the sink with water and placing the item in the full sink of water. Not only does this technique use an excessive amount of water, the item often does not thaw evenly as the food often floats to the surface, leaving only a portion of the item submerged in the water. In order to thaw the item in this scenario, the user periodically rotates the item or attempts to submerge the item by placing a heavy object on it. Whether the user is rotating the frozen item or ensuring that it remains submerged by the heavy object, this technique generally requires significant supervision, is time-consuming, and does not ensure that the entire surface area of the frozen item is exposed to the water so that heat exchange can occur on substantially the entire surface area of the frozen item.

### SUMMARY

The present disclosure provides an apparatus for thawing a frozen item. In one embodiment, the apparatus comprises a frame member generally defining a shape of a thawing portion of the apparatus; a retention member coupled to the frame member to provide the thawing portion of the apparatus, the thawing portion operable to retain the frozen item in a liquid and operable to allow the liquid to pass through the retention member; and one or more anchor members coupled to at least one of the frame member and the retention member, the one or more anchor members operable to secure the apparatus to a surface of a container containing the liquid.

In another embodiment, the present disclosure provides an apparatus for thawing a frozen item, wherein the apparatus comprises a thawing portion operable to retain the frozen item in a liquid such that the liquid surrounds substantially the entire surface area of the frozen item to allow for heat transfer between substantially the entire surface area of the frozen item and the liquid; and one or more anchor members coupled to the thawing portion, the one or more anchor members operable to secure the apparatus to a surface of a container containing the liquid.

The present disclosure also provides a method for thawing a frozen item. In one embodiment, the method comprises placing the frozen item in a container operable to contain a liquid; and affixing one or more anchor members of an apparatus to a surface of the container such that a portion of the apparatus retains the frozen item in a liquid contained in the container such that the liquid surrounds substantially the entire surface area of the frozen item to allow for heat transfer between substantially the entire surface area of the frozen item and the liquid.

The foregoing and other features and advantages of one or more various embodiments of the present disclosure will become further apparent from the following detailed description of the embodiments, read in conjunction with the accompanying drawings. The description and drawings are merely illustrative of one or more various embodiments of the disclosure, rather than limiting the scope of the invention.

### BRIEF DESCRIPTION OF THE DRAWINGS

Embodiments are illustrated by way of example in the accompanying figures (not necessarily shown to scale), in which like reference numbers indicate similar parts, and in which:

FIG. 1 illustrates a perspective view of an embodiment of the disclosed apparatus for thawing a frozen item;

FIGS. 2A and 2B illustrate various views of components comprising an embodiment of the disclosed apparatus for thawing a frozen item; and

FIG. 3 illustrates an example use of an embodiment of the disclosed apparatus for thawing a frozen item.

### DETAILED DESCRIPTION OF THE DRAWINGS

The present disclosure provides a method and apparatus for thawing a frozen item. In general, the disclosed apparatus is capable of suspending or retaining a frozen item, typically a frozen food such as steak, poultry, or fish in a liquid (e.g., water) such that the frozen item remains submerged, thus allowing for the transfer of heat from the liquid to substantially the entire surface area of the frozen item, thereby accelerating the thawing process and ensuring an even thaw. This allows the user to monitor and/or conserve use of the liquid by using a desired amount (typically just enough to fully submerge the frozen item so that the liquid surrounds substantially the entire surface area of the frozen item and/or so that the liquid can circulate above and below the submerged frozen item). Moreover, because the frozen item remains submerged, the user does not have to rotate, flip or otherwise tend to the frozen item to ensure an even thaw.

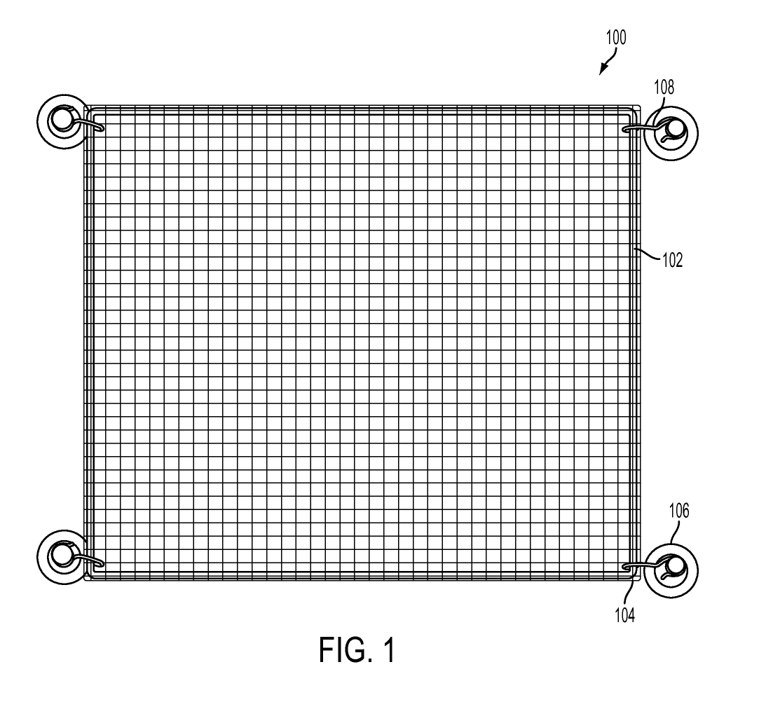

One embodiment of the disclosed apparatus for thawing a frozen item is illustrated in FIG. 1. The apparatus 100 shown in FIG. 1 comprises a frame member 102, retention member 104, anchor members 106, and connectors 108. The frame member 102 and retention member 104 generally define what is referred to herein as the thawing portion of the apparatus 100, which is the portion of the apparatus 100 that most interfaces with the frozen item to be thawed. In the case of thawing food, the thawing portion is the portion of the apparatus 100 that retains the food that is to be thawed as further explained herein. It should be appreciated that, in some embodiments, the apparatus may not include a frame member 102. In such embodiments, the retention member 104 may comprise the entirety of the thawing portion, or at least a substantial percentage thereof.

Referring again to FIG. 1, the frame member 102 generally defines the shape of the thawing portion of the apparatus 100. Although the frame member 102 shown in FIG. 1 defines a rectangular shape, it should be appreciated that the frame member 102 may define any shape including, but not limited to, a triangle, star, circle, or any other shape capable of retaining the item to be thawed. In some embodiments, the frame member 102 may be comprised of a flexible material such as, for example, string, twine, rope, thread or fabric. In other embodiments, the frame member 102 may be comprised of a more rigid material such as, for example, a wire or plastic.

The retention member 104 is coupled (e.g., by folding, stitching, molding or other known methods), in some embodiments, to the frame member 102 and is capable of retaining the frozen item in a liquid during the thawing process. In some embodiments, the retention member 104 may be comprised of a flexible material or a rigid material, or a combination thereof. For example, in some embodiments, the retention member 104 may be comprised of metal, plastic, rubber, fabric, or any combination thereof. In some embodiments, the retention member 104 may comprise a perforated material such as a netting, mesh, or similar material that is capable of retaining the frozen item while allowing the liquid to flow or seep through various openings in the retention member 104. In embodiments in which the frame member 102 is not included, the retention member 104 defines the shape of the thawing portion of the apparatus 100, which may be any shape.

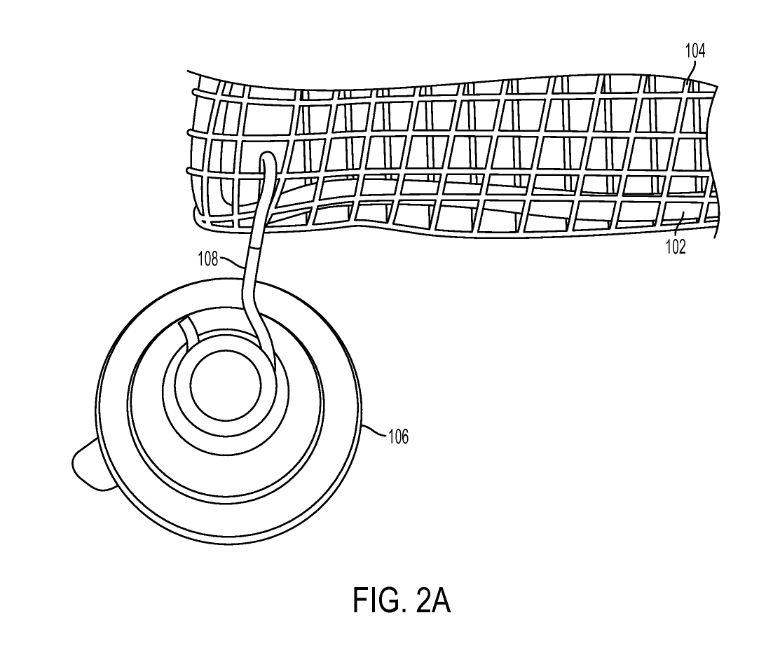

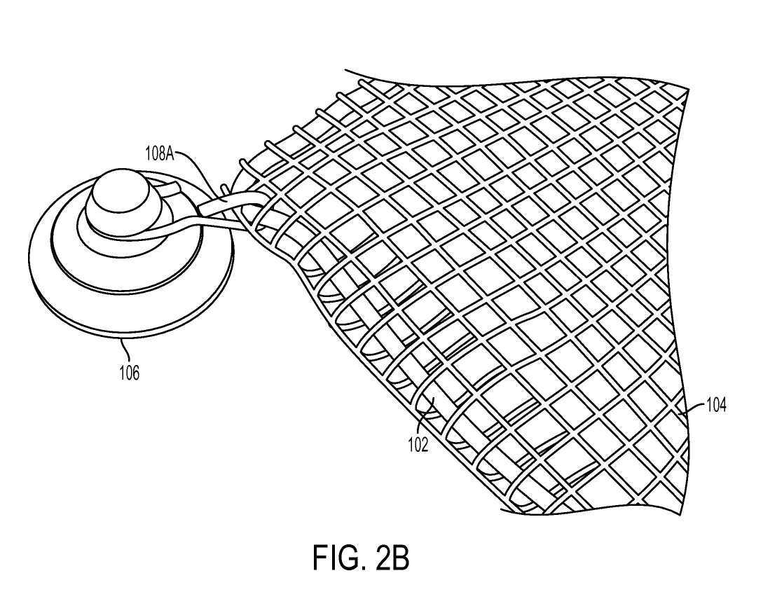

Anchor members 106 are attached to the thawing portion of the apparatus 100 via connectors 108. Specifically, each of the anchor members 106 may be attached at any location to the frame member 102, retention member 104, or both using a connector 108. A connector 108 may be comprised of a flexible material (e.g., string, twine, rope, thread, fabric, etc.) or a rigid material (e.g., metal, plastic, etc.). In some embodiments, the anchor members 106 may include a suction cup or other means (e.g., magnet, hook, hook-and-loop fastener, sticky material, etc.) of connecting, fastening, or affixing the apparatus 100 to a surface of the container (e.g., sink) containing the liquid. In some embodiments, such as that illustrated in FIGS. 2A and 2B, the connector 108 may include a curved or arcuate portion 108A (see FIG. 2B) to allow the position of the thawing portion to adjust relative to the position of the attached anchor member 106. As such, each anchor member 106 may be positioned as desired to maintain a preferred position of the thawing portion and/or anchor member 106. Such positioning may allow the apparatus 100 to operate as desired while accommodating, for example, containers or frozen items of various sizes and shapes. This positioning may also be achieved by using a flexible connector.

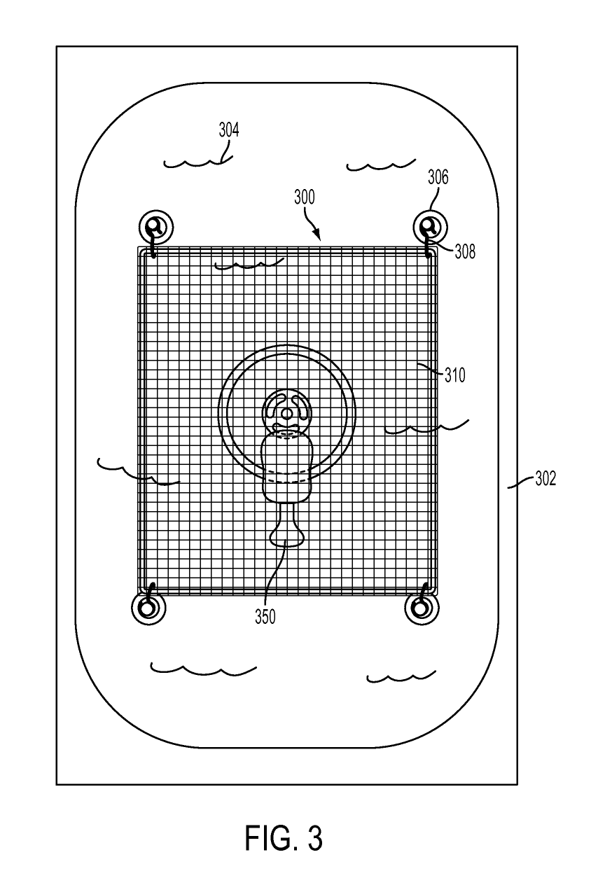

FIG. 3 illustrates an example embodiment of the present disclosure, wherein an embodiment of the disclosed apparatus 300 is used to thaw a frozen meat 350. In accordance with the embodiment illustrated in FIG. 3, the frozen meat 350 is placed in a container 302 (e.g., sink, cooler, bucket, bowl, etc.) capable of containing a liquid 304 (e.g., water), and the apparatus 300 is affixed to the container 302 via anchor members 306 so that the thawing portion 310 retains the frozen meat 350 so that it is completely submerged in the liquid 304. As discussed above, by retaining the frozen meat 350 in the liquid 304, the apparatus 300 allows for the transfer of heat from the liquid 304 to substantially the entire surface area of the meat 350, thereby accelerating the thawing process and ensuring an even thaw. This allows the user to monitor and/or conserve use of the liquid 304 by using a desired amount (typically just enough to fully submerge the frozen meat 350 so that the liquid 304 surrounds substantially the entire surface area of the frozen meat 350 and/or so that the liquid 304 can circulate above and below the submerged frozen meat 350). The frozen meat 350 remains submerged, thereby relieving the user of the responsibility of rotating, flipping or otherwise tending to the frozen meat 350 to ensure an even thaw.

Once the meat 350 is thawed, the meat 350 may be retrieved from the apparatus 300, for example, by disengaging one or more of the anchor members 306 from the container 302. Alternately, the apparatus may be disassembled or partially disassembled by detaching one or more anchor members 306 from their respective connectors 308 so that the thawed meat may be retrieved. The apparatus 300 may be removed by disengaging the anchor members 306 from their respective surfaces of the container 302. It should be appreciated that the anchor members 306 may be affixed to any surface of the container 302 including a bottom or side surface. Furthermore, the apparatus 300 may be affixed to the container 302 either before, during, or after the liquid 304 is placed in the container 302.

It should be appreciated by one of ordinary skill in the art that the depth at which the frozen meat 350 is retained (i.e., submerged) may be altered or controlled by adjusting the placement (e.g., lateral or vertical placement) of one or more of the anchor members 306 relative to the other anchor members 306 of the apparatus 300. For example, in accordance with the embodiment illustrated in FIG. 3, to increase the depth at which the frozen meat 350 is submerged, one or more of the anchor members 306 may be placed at a greater distance from the other anchor members 306 to reduce slack in the thawing portion 310 (e.g., retaining member) of the apparatus 300, thereby reducing the vertical displacement of the frozen meat 350 relative to the placement of the anchor members 306. Conversely, to decrease the depth at which the frozen meat 350 is submerged, one or more of the anchor members 306 may be placed at a lesser distance from the other anchor members 306 to increase slack in the thawing portion 310 of the apparatus 300, thereby increasing the vertical displacement of the frozen meat 350 relative to the placement of the anchor members 306. This technique may also be used to adjust the positioning of the apparatus 300 to accommodate containers 302 and/or frozen meats 350 of various shapes and sizes.

Various adaptations or alternate uses of the disclosed apparatus are considered within the scope of the present disclosure. For example, in some embodiments, the disclosed apparatus may be affixed entirely to a side or top surface of a container so that the remaining volume of the container may be used for other purposes. Additionally, the apparatus may include a greater or lesser number of anchor members than described in the foregoing embodiments. Furthermore, the anchor members may be attached at locations other than those illustrated in the figures. For example, in some embodiments, one or more anchor members may be attached to an interior section of the thawing portion rather than the perimeter as shown in FIGS. 1, 2A, 2B and 3.

Additionally, it should be appreciated that the disclosed apparatus may also be used, in some embodiments, to retain a frozen item that is predisposed to sinking in the liquid by placing the apparatus below the frozen item, rather than above the frozen item. Furthermore, if the frozen item is likely to float once thawed, a second apparatus may be placed above the first apparatus to ensure that the thawed item remains submerged in the liquid. Similarly, in some embodiments, such as that described above with reference to FIG. 3, a second apparatus may be placed below a first apparatus to retain a thawed item that is likely to sink once thawed.

The figures and text provided herein are provided to disclose aspects of the invention and/or to provide one or more examples of various embodiments of the present disclosure. The examples and embodiments provided herein are not intended to limit the scope or spirit of the present disclosure as defined in the claims provided below.

What is claimed is:

1. An apparatus for thawing a frozen item, the apparatus comprising:
a frame member generally defining a shape of a thawing portion of the apparatus;
a retention member coupled to the frame member to provide the thawing portion of the apparatus, the thawing portion operable to retain the frozen item in a liquid and operable to allow the liquid to pass through the retention member; and
one or more anchor members coupled to at least one of the frame member and the retention member, the one or more anchor members operable to secure the apparatus to a surface of a container containing the liquid.

2. The apparatus as set forth in claim 1, further comprising one or more connectors, each connector operable to couple one of the one or more anchor members to at least one of the frame member and the retention member.

3. The apparatus as set forth in claim 1, wherein the apparatus is operable to retain the frozen item in the liquid such that the liquid surrounds substantially the entire surface area of the frozen item.

4. The apparatus as set forth in claim 1, wherein the frame member includes at least one of a group including a twine, string, rope, thread, wire, fabric and plastic.

5. The apparatus as set forth in claim 1, wherein the retention member comprises a perforated material.

6. The apparatus as set forth in claim 1, wherein at least one of the one or more anchor members comprises a suction cup.

7. The apparatus as set forth in claim 1, wherein the apparatus is operable to adjust a depth that the frozen item is retained in the liquid.

8. The apparatus as set forth in claim 1, wherein the apparatus is operable to allow for heat transfer between substantially the entire surface area of the frozen item and the liquid.

9. The apparatus as set forth in claim 1, wherein the apparatus is operable to retain the frozen item in the liquid such that the liquid is capable of circulating above a top surface of the frozen item.

10. The apparatus as set forth in claim 1, wherein the apparatus is operable to retain the frozen item in the liquid such that the liquid is capable of circulating below a bottom surface of the frozen item.

11. The apparatus as set forth in claim 1, wherein the apparatus is operable to retain the frozen item in the liquid such that the liquid is capable of circulating above a top surface of the frozen item and below a bottom surface of the frozen item.

12. A method for thawing a frozen item, the method comprising:
placing the frozen item in a container operable to contain a liquid; and
affixing one or more anchor members of an apparatus to a surface of the container such that a portion of the apparatus retains the frozen item in a liquid contained in the container such that the liquid surrounds substantially the entire surface area of the frozen item to allow for heat transfer between substantially the entire surface area of the frozen item and the liquid.

13. The method as set forth in claim 12, wherein the apparatus further comprises:
a frame member generally defining a shape of a thawing portion of the apparatus; and
a retention member coupled to the frame member to provide the thawing portion of the apparatus.

14. The method as set forth in claim 12, wherein the portion of the apparatus retains the frozen item in the liquid such that the liquid is capable of circulating below a bottom surface of the frozen item.

15. The method as set forth in claim 12, wherein the portion of the apparatus retains the frozen item in the liquid such that the liquid is capable of circulating above a top surface of the frozen item.

16. The method as set forth in claim 12, wherein the portion of the apparatus retains the frozen item in the liquid such that the liquid is capable of circulating above a top surface of the frozen item and below a bottom surface of the frozen item.

17. The method as set forth in claim 12, further comprising adjusting a placement of at least one of the one or more anchor members to adjust a depth that the frozen item is retained in the liquid.

18. The method as set forth in claim 12, wherein the apparatus is operable to allow the liquid to flow through the portion of the apparatus retaining the frozen item in the liquid contained in the container.

19. An apparatus for thawing a frozen item, the apparatus comprising:
a thawing portion operable to retain the frozen item in a liquid such that the liquid surrounds substantially the entire surface area of the frozen item to allow for heat transfer between substantially the entire surface area of the frozen item and the liquid; and
one or more anchor members coupled to the thawing portion, the one or more anchor members operable to secure the apparatus to a surface of a container containing the liquid.

20. The apparatus as set forth in claim 19, wherein the thawing portion comprises:
a frame member generally defining a shape of the thawing portion of the apparatus; and
a retention member having a plurality of openings, the retention member coupled to the frame member and operable to allow the liquid to pass through the plurality of openings in the retention member.
